(19) United States
(12) Patent Application Publication
(10) Pub. No.: US 2002/0112404 A1
(43) Pub. Date: Aug. 22, 2002

(54) Drive device for a motor vehicle sliding door

(76) Inventor: Minh Au Truong, Chatenay-Malabry (FR)

Correspondence Address: YOUNG & THOMPSON, 745 SOUTH 23RD STREET 2ND FLOOR, ARLINGTON, VA, 22202

(21) Appl. No.: 10/062,514

(22) Filed: Feb. 5, 2002

(30) Foreign Application Priority Data
Feb. 5, 2001 (FR) 01 01 516

(51) Int. Cl. E05F 11/00

(52) U.S. Cl. 49/360

(57) ABSTRACT

A driver for a motor vehicle sliding door includes a mechanical member for transmitting a torque provided by a slaved motor and a flexible hauling element located outside the vehicle. The hauling element is connected to the door (2) via a carriage (10) that can move in a drive rail (8). The device includes, at one end (15) of the rail (8), a member (61) for the reversible driving of the hauling element, connected to the transmission member, and, at the other end (17) of the rail, a member (41) for returning the hauling element.

The present invention relates to a drive device for a motor vehicle sliding door, of the type comprising a mechanical member for transmitting a torque provided by a slaved motor, the said member and the said motor being arranged at least partly inside the vehicle, a flexible hauling element located outside the vehicle and to which the door is connected via a carriage that can move in a drive rail, the said rail delimiting an external contour for holding on part of the bodywork of the vehicle.

Such devices are fitted to vehicles with one or more sliding doors, often arranged at the sides of the vehicle. Automated opening and closure of doors equipped with one of these devices are advantageous in terms of comfort and safety.

However, most of these devices occupy very significant volumes, both inside and outside the bodywork of the vehicle. Thus, it is often the case that the drive members and torque-transmission members protrude to a large extent into the cabin space, while storing the inactive lengths of the hauling element or elements, such as cables, entails bulky systems mounted more or less completely as protrusions on the outside of the vehicle, giving it an external appearance which is a departure from the overall style of the bodywork.

Furthermore, these devices entail complex assembly because of the fixing of a great many elements for driving and guiding the hauling element and/or the door, at locations which are often difficult to access either from inside or from outside the bodywork. The adjusting of such devices is thereby compromised and all the fitting constraints have therefore to be taken into consideration right from the time that the vehicle bodywork is designed. Problems with sealing and wear also remain very pronounced.

One of the objectives of the present invention is to propose a compact device that can be fitted to all types of existing vehicle equipped with at least one sliding side door and which is simple to fit without requiring adjustment.

To this end, the subject of the invention is a device of the aforementioned type and which comprises, at one end of the rail, a member for the reversible driving of the hauling element, connected to the transmission member, and, at the other end of the rail, a member for returning the hauling element.

According to other features of the invention, taken in isolation or in any technically feasible combination:

the return member is arranged more or less inside the continuation of the external contour of the rail;

the drive member is arranged more or less inside the continuation of the external contour of the rail;

the return member comprises an element for guiding the rotation of the hauling element about a return axis;

the return member is housed in a casing that is stationary with respect to the rail, and the return member comprises means for tensioning the hauling element by shifting the return axis with respect to the casing;

the tensioning means comprise a spring bearing against the rotational-guidance element, the said element being able to move in translation along the longitudinal axis of the end of the drive rail;

the rotational-guidance element consists of a pulley, the spring pressing indirectly against this pulley via a yoke;

the drive member comprises a pulley for driving the hauling element by friction, comprising at least one wrapping of the hauling element;

the point at the start of wrapping and the point at the end of wrapping of the hauling element around the pulley lie on the same side of the pulley that faces towards the end of the drive rail;

the pulley comprises a cylindrical central portion which transversely has a concave profile which defines a hollowed surface keeping the wrappings of the hauling element contiguous without overlap;

the surface of the cylindrical central part of the pulley comprises at least one groove oriented more or less along the axis of the pulley, and the hauling element consists of a cable comprising, at least in its part designed to be wrapped around the pulley, beads secured to the cable and of a shape that is the conjugate of the groove;

the distance between two successive beads is more or less equal to a multiple of the peripheral distance separating two successive grooves;

in the case of a pulley comprising four grooves, the beads are distributed at a spacing more or less equal to a multiple of three-quarters of the perimeter of the pulley;

the drive rail delimits a space for holding the carriage, and the hauling element comprises two ends arranged inside the holding space and a return strand running alongside the drive rail outside the said space;

the drive rail is provided with at least one runner for the sliding of the return strand;

the carriage comprises two guide rollers between them delimiting a gap comprising at least one location for fixing the ends of the hauling element;

the carriage comprises a connecting strip connecting the two fixing locations together.

A further subject of the invention is a vehicle equipped with at least one sliding side door, which is driven by a device as described hereinabove.

The invention will be better understood from reading the description which will follow, which is given solely by way of example and made with reference to the appended drawings, in which:

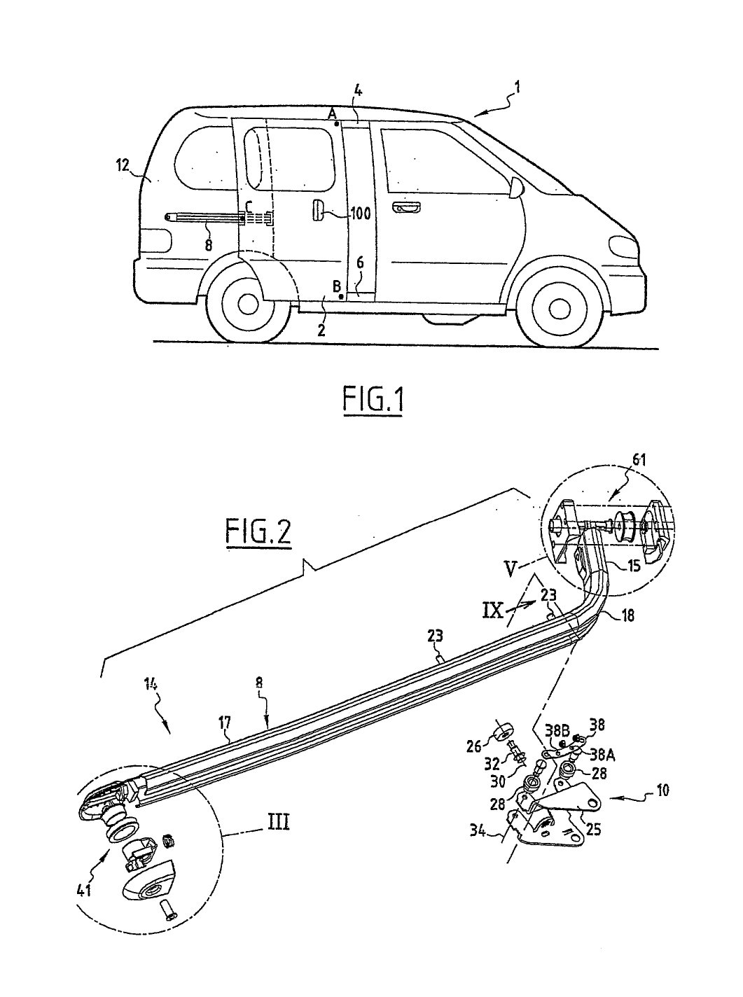

FIG. 1 is a schematic side view of a motor vehicle with a sliding door equipped with a device according to the invention;

FIG. 2 is an exploded perspective view of part of the device according to the invention, arranged outside the bodywork of the vehicle of FIG. 1;

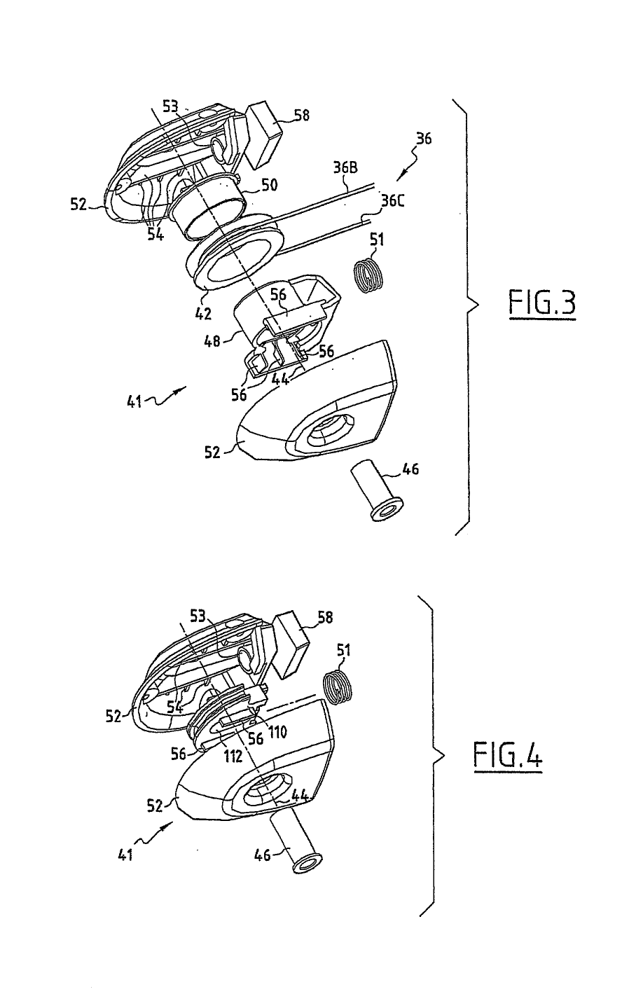

FIG. 3 is an exploded perspective view of detail III in FIG. 2;

FIG. 4 is a view similar to FIG. 3, but of another embodiment according to the invention of the detail of FIG. 3;

FIG. 5 is an exploded perspective view of detail V in FIG. 2;

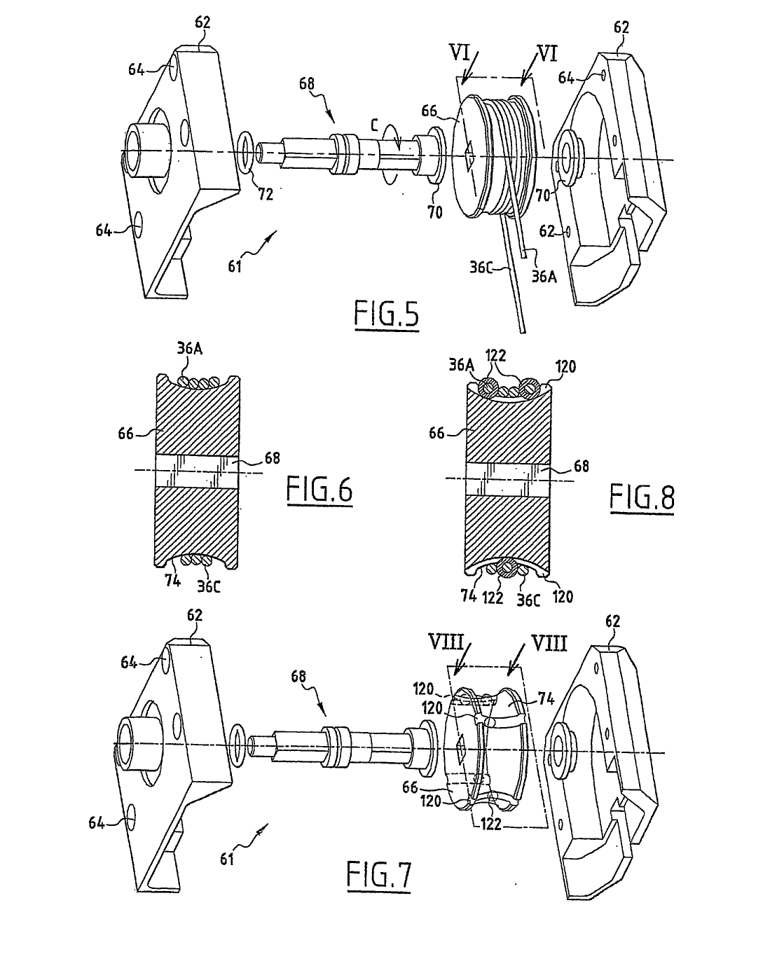

FIG. 6 is a view in section on VI-VI shown in FIG. 5;

FIG. 7 is a view similar to FIG. 5, but according to another embodiment according to the invention, of the detail of FIG. 5;

FIG. 8 is a view in section on VIII-VIII shown in FIG. 7;

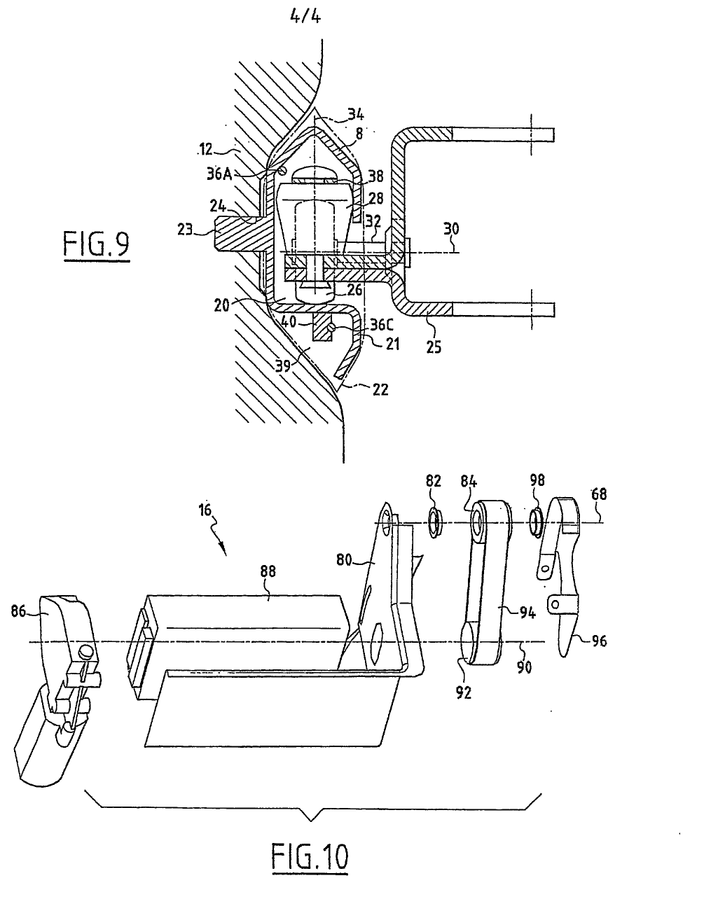

FIG. 9 is a view in section on IX-IX shown in FIG. 2;

FIG. 10 is an exploded perspective view of part of the device according to the invention arranged inside the bodywork of the vehicle of FIG. 1.

FIG. 1 depicts a vehicle 1 with a sliding side door 2, this door being in a part open position.

The vehicle 1 depicted is very schematic and is merely one illustrative example. The invention applies to any rolling vehicle that has at least one sliding door, whether this vehicle be of a utility or comfort nature. Likewise, in all that follows, the example expounded will be based on an arrangement of the sliding door on the right-hand side of the vehicle, but the invention obviously applies to a sliding door arranged on the opposite side of the vehicle. Finally, the slidings envisaged are in a direction from front to back of the vehicle (that is to say from right to left in FIG. 1), as far as opening the door is concerned, and from back to front as far as closing the door is concerned. Of course, the orientation of these sliding movements can be reversed for vehicles of different design.

The sliding door 2 is fixed to the vehicle 1 at three points of contact, each of them sliding in a corresponding rail. Thus, an upper rail 4 is mounted in the upper part of the bodywork near the roof of the vehicle, for example above the side windows. Likewise, a lower rail 6 is mounted in the lower part of the bodywork, near the floor of the vehicle. Finally, an intermediate rail 8 is arranged between the rails 4 and 6. The door 2 is guided in each of these rails respectively by means of a carriage, each comprising at least one bearing roller which rolls along inside the rail. The carriages of the upper and lower rails are passive, experiencing the driving of the door; they are of the prior art. By contrast, the intermediate rail 8 forms a longitudinal region where the door 2 is driven, as it slides, the door being supported by a carriage 10 arranged according to the invention.

The three carriages connecting the door 2 to the remainder of the vehicle 1 are arranged in a more or less triangular configuration, each vertex of the triangle consisting of a carriage and indicated schematically by the points A, B and C in FIG. 1. The upper (point A) and lower (point B) carriages are fixed internally to the door, on its right-hand part, the upper and lower rails therefore extending longitudinally to the opening delimited by the door slid into the open position. The intermediate carriage 10, schematized by the point C in FIG. 1, is fixed to the left-hand part of the door, the associated rail 8 therefore extending along a fixed part of bodywork 12 situated in the backward continuation of the aforementioned opening.

The device for driving the door 2 according to the invention is arranged both on the inside and on the outside of the bodywork 12 of the vehicle 1. FIG. 2 depicts part 14 of the device arranged on the outside, while FIG. 10 depicts another part 16 of the device which is arranged on the inside with respect to the bodywork 12 of the vehicle.

FIG. 2 depicts the rail 8 and the associated carriage 10. In order not to overload the drawing, the door 2 and the bodywork 12 of the vehicle 1 are not reproduced. The rail 8 comprises, in the example shown, a first end part 15, which is more or less straight, and a second end part 17, which is more or less straight, and oriented at a certain angle with respect to the first part 14. The parts 15 and 17 are connected by a curved rail part 18. The part 15, in the same more or less horizontal plane of the rail parts 17 and 18, is designed to allow the sliding door 2 to align itself, more or less in the same plane in the closed position, with all the bodywork elements on the left-hand side of the vehicle 1. When the door is opened, the rail part 15 allows the door 2 to be disengaged from the aforementioned plane, by bringing it into a plane more or less parallel to the aforementioned plane, but moved outwards from the vehicle.

In cross section and as depicted in FIG. 9, the rail 8 internally delimits a space 20 for holding the carriage 10. Furthermore, the rail comprises, below the holding space 20, a wall 21 directed more or less downwards and the shape of which is arranged by bending.

The rail 8 follows the external surface of the bodywork 12 and defines an overall external contour bulk 22, depicted in chain line in FIG. 9, and the shape of which collaborates with the more or less complementing contour of the bodywork 12. The rail 8 is thus integrated into the vehicle bodywork as far as possible, preventing any angular projections when viewed from the outside.

The rail 8 additionally comprises, on its surface in contact with the bodywork 12, several projections 23 oriented towards the inside of the vehicle and designed to collaborate with cavities 24 of complementary shape formed in the bodywork 12. The rail 8 is held, at least in part, by means of these projections 23 so that it can be removed and refitted easily according to arrangements of the prior art.

As depicted in FIGS. 2 and 9, the carriage 10 secured to the door 2 comprises a support structure 25 to which a bearing roller 26 and two guide rollers 28 are articulated. The bearing roller 26 is mounted so that it is free to rotate about an axis 30 more or less perpendicular to the bodywork 12 and embodied, for example, by a pin 32. The guide rollers 28, arranged one on each side of the bearing roller 26, are mounted so that they are free to rotate about a more or less vertical axis 34, which is therefore more or less perpendicular to the axis 30. The bearing roller 26 presses against the bottom surface of the holding space 20, while the guide rollers 28 press against the lateral surfaces of this space 20.

The carriage 10 is connected to a hauling element 36 designed to drive the carriage 10 in the rail 8 reversibly. This element 36 is depicted in the figures in the form of a cable with a metal core and more or less round cross section, but this element can just as easily consist of a belt, a perforated band, or a rack cable for example. The two ends of this cable 36 are fixed to the carriage 10, at a connecting strip 38. This strip extends between the two guide rollers 28 and is fixed in the region of the axis 34 of each of them. The two ends of the cable 36 are securely fastened to the strip 38, each at an attachment point 38A, 38B, using fasteners.

The cable 36 therefore extends partly inside the holding space 20 of the rail 8, thus forming two upper end parts 36A and 36B, from the respective attachment points 38A and 38B as far as the corresponding end of the rail where it is arranged with the arrangements detailed hereinbelow. The cable 36 extends in return under and right along the rail 8, thus forming a lower strand 36C. The lower strand 36C is arranged inside a longitudinal cavity 39 formed underneath between the bent wall 21 of the rail and the surface of the bodywork 12.

As depicted in FIG. 9, at least one guide element 40 is fixed to the bottom wall of the rail 8 inside this cavity 39 so as to ease the sliding of the lower strand 36C. At the curved part 18 of the rail 8, at least one guide element 40 makes this sliding easier during the change in direction imposed by the curvature of the rail. The bent wall 21 thus hides the lower strand 36C and the guide elements 40.

Arranged at the rear end of the rail 8 is a member 41 for returning the cable 36, which member is depicted in detail in FIG. 3.

This member 41 comprises a pulley 42 mounted so that it is free to rotate about an axis 44 that is more or less coincident in FIG. 3 with the axis of a spacer ring 46. The member 41 also comprises a yoke 48, coaxial with the pulley 42 and pressing against this pulley, advantageously via a bearing 50 arranged between the yoke and the pulley. The yoke 48 is mounted so that it can move in translation in the longitudinal direction of the associated end of the rail 17. The bearing 50 provides the pulley 42 with rotational guidance.

The cable 36 is wrapped by half a turn around the pulley 42, the lower strand 36C extending from the lower start-of-wrapping point of the cable onto the pulley and the end part 36B of the cable extending from the upper start-of-wrapping point.

The member comprises a spring 51 arranged against the yoke 48, the spring 51 being mounted in the compressed state. This spring 51 and the yoke 48 at least partly define means for tensioning the cable 36.

The elements of the member 41 described previously are arranged inside a casing 52 formed of two juxtaposed monobloc parts. This casing 52 comprises a ring 53 onto which the spring 51 is partially slipped. This casing is additionally provided with reinforcing ribs 54, some of which collaborate with associated ribs 56 with which the yoke 48 is provided when the casing 52 is closed by means of the ring 46.

The member 41 additionally comprises a stop 58 made of an elastic material with a high impact-absorption capacity. This stop 58 is placed on the face of the casing 52 that faces towards the end of the rail 17 and is designed to undergo contact of the impact type with the carriage 10.

Arranged at the front end of the rail 8 is a member 61 for driving the cable 36 depicted in detail in FIG. 5.

This member 61 comprises a protective case 62 made of two juxtaposed parts secured together and secured to the bodywork of the vehicle 1 by means of fasteners, not depicted, which use the perforations 64 made in the case 62.

Inside the case 62, the member 61 comprises a pulley 66 secured to a rotation shaft 68 and guided by bearings 70. The shaft 68 is sized so that it passes through the bodywork 12 and protrudes by enough that it can be driven from inside the vehicle 1. Seals, such as the seal 72, are arranged on the shaft 68 and press against the casing 64.

The cylindrical part of the pulley 66 has a configured surface onto which 3.5 turns of the cable 36 are wrapped. As depicted in FIG. 6, the profile, in longitudinal section, of this cylindrical part of the pulley 66 is concave, and this forms a hollowed surface 74 on which the turns of the cable 36 spread out contiguously without overlap. The pulley 66 receives the end part 36A of the cable at its upper start-of-wrapping point and the return strand 36C at its lower-start-of-wrapping point, these upper and lower wrapping points lying on the same side facing towards the end of the rail 15.

FIG. 10 depicts the part 16 of the device according to the invention arranged inside the bodywork 12 of the vehicle 1.

This part 16 is of an architecture that varies according to the vehicle on which it is arranged so that it occupies volumes which are rendered unusable and/or hollow thicknesses in the vehicle body.

In the example depicted in FIG. 10, the part 16 comprises a mounting plate 80 forming the support structure for the other components of the part 16 and delimiting the points (not depicted) of attachment to the body of the vehicle 1.

This mounting plate 80 is provided with a friction ring 82 on which a pulley 84 is arranged. The pulley 84 is mounted on the shaft 68 of the member 61 for driving the cable 36; only the axis of the shaft 68 has been depicted in FIG. 10.

The mounting plate 80 supports both a geared motor unit 86 and an electronic control unit 88 for controlling this motor 86 and for interfacing with the electronics of the vehicle 1. These elements 86 and 88 are depicted only very diagrammatically because they do not form part of the invention but of the known art. The axis of the output shaft of the geared motor unit 86 is denoted 90, it being understood that the layout and arrangements relating to this shaft optimize the use of unusable space.

A pulley 92, mounted directly on the axis 90, is connected to the pulley 84 via a torque-transmission element 94, depicted in FIG. 10 in the form of a toothed belt.

It should be noted that, upon assembly, it is advantageous to use one of the points of attachment of the geared motor unit 86 as a point of pivoting with respect to the others, particularly in order to tension the belt 94. By rotating the body of the motor 86 slightly, the pulleys 84 and 92 are moved closer together or further apart, the distance between their axes being modified. When set, all that is required is for the various points of attachment of the motor to the mounting plate 80 to be immobilized in turn.

The way in which the device according to the invention and which has just been described works is as follows.

At rest, that is to say with the door 2 immobile in the open position or in the closed position, the member 41 for returning the cable 36 tensions this cable because the spring 51, initially mounted in a compressed state, constantly exerts a thrusting force in the direction of the cable 36 and oriented towards the rear of the vehicle. This force is applied to the yoke 48 moving the latter in terms of translation-and therefore moving the pulley 42 inside the casing 52 as long as the intensity of the opposing force of the tension in the cable 36 has not reached a value that allows the forces to reach equilibrium.

In order to describe the overall operation of the device according to the invention, we start in the case where the door 2 of the vehicle 1 is opening, that is to say is moved from right to left in FIG. 1.

The instruction commanding opening of the door is given, for example by simple pressure on a handle 100 of the door 2. The vehicle electronics then send a corresponding signal to the control unit 88, which actuates the shaft 90 of the geared motor unit 86. Via the toothed belt 94, the pulley 84 is driven and imparts the driving torque to the shaft 86. In the example under consideration, the shaft 86 is driven in the direction indicated in FIG. 5, by the curved arrow C.

The shaft 68 transmits the driving torque to the pulley 66, the pulley 66 then, by friction, driving the taut cable 36.

The lower strand 36C is consequently pulled towards the front of the vehicle 1, its progress under the bent wall 21 of the rail 8 being facilitated by the guide elements 40. Being mounted so that it is free to rotate, the pulley 42 of the return member 41 is driven in rotation by the cable 36, the upper strand 36B being pulled towards the rear of the vehicle around the pulley 42. As the end 36B of the cable is securely attached to the strip 38 at the attachment point 38B, the carriage 10 is pulled by the cable 36 and moves inside the holding space 20 of the rail 8 towards the rear of the vehicle 1. The carriage 10 is moved by the rotation of the bearing roller 26 and guidance of the rollers 28. As the door 2 is secured to the carriage 10, the translational movement in the direction of the rail 8 is imparted to the door 2, which slides along the side of the vehicle 1, driving with it the upper and lower carriages which travel in the upper rail 4 and lower rail 6 respectively.

The end part 36A of the cable, securely fastened to the strip 38 at the attachment point 38A, is driven towards the rear of the vehicle, unwrapping from the pulley 66 of the drive member 61.

Throughout the travel involved in opening the door 2, the lower part 36C of the cable 36 becomes wrapped around the pulley 66, while another part of the cable, the upper end part 36B, becomes unwrapped. The pulley 66 therefore constantly has 3.5 turns of cable around it. The hollowed surface 74 of the cylindrical part of the pulley 66 allows the cable to be driven by friction, the successive turns located furthest towards the outside of this part holding the others and avoiding overlaps.

The device according to the invention can be fitted to any existing vehicle that has a door that slides in a rail. The door driving cable 36 makes use of the arrangement of the rail on the bodywork, and of the driving 61 and return 41 members which are housed in tight spaces, only in the continuation of the external contour 22 of the rail 8. In consequence, the device according to the invention is discrete and, on the outside as on the inside, can be fully integrated into the vehicle.

Furthermore, the device is easy to fit. The return member 41 is compact enough to replace one end-stop element which is very commonly fitted at the end of travel of the rail. The cable 36 is automatically tensioned by means of the spring 51 without any additional adjustment, and this offers the advantage that geometric spread on the components associated with the cable tension need not be taken into consideration. As to the part of the device which is arranged inside the bodywork, its arrangement is very flexible, particularly so that it can be made to best suit the unused spaces in the vehicle body. For that purpose, the torque transmission element 94 may be arranged in the form of a chain, of a universal joint or of a belt with a suitable profile.

In addition, the device offers good reliability, the components which are the most vulnerable and the most sensitive to attack of all types being arranged inside the protective casings 52 and 62, possibly sealed.

As an alternative, not depicted, to the device according to the invention, the part 16 comprises a monobloc component made of polymer replacing the mounting plate 80 and the unit 88. This component then acts both as a rigid structure and as a box designed to house the control electronics for the device.

FIG. 4 depicts an alternative form of embodiment of the return member 41. Elements which are common to FIGS. 3 and 4 carry the same references, the FIG. 4 variant differing from the member 41 of FIG. 3 as follows.

The assembly consisting of the bearing 50, of the pulley 42 and of the yoke 48 is replaced by a half-pulley 110 of axis 44 and provided with a central orifice 112 of more or less oblong shape. The half-pulley 110 additionally comprises ribs 56 designed to collaborate with some of the projections 54 of the casing 52. The half-pulley 110 is thus mounted so that it can move in translation in the longitudinal direction of the rail part 17. The translational movement is controlled as before by the spring 51 mounted compressed on the ring 53 and is allowed because of the significant clearance formed by the oblong orifice 112, the spring 51 and the orifice 112 at least partially forming the means of tensioning the cable 36. The ribs 56 guide the translation of the half-pulley 110.

The way in which the device works is similar to the way explained previously, except that since the half-pulley 110 has no freedom of rotational movement, the cable 36 is articulated about this half-pulley 110 only in sliding.

This alternative form of embodiment of the return member 41 has the advantage of being even more compact than the previous one, while at the same time fulfilling the same functions. It is therefore particularly well suited to vehicles whose architecture offers only a very small amount of space at the rear end of the drive rail B.

FIGS. 7 and 8 depict an alternative form of embodiment of the drive member 61. Elements which are common to FIGS. 5-6 and 7-8 respectively carry the same references, the alternative form of FIGS. 7 and 8 differing from the member 61 of FIGS. 5 and 6 as follows. The pulley 66 has four grooves 120, formed in a direction more or less parallel to the axis of the pulley 66 on the surface 74 of its cylindrical part and distributed in a more or less uniform way.

In addition, the cable 36 is equipped, at least in its part called upon to be wrapped around and/or unwrapped from the pulley 66, beads 122 secured to the cable and distributed uniformly.

In the example depicted, the pulley 66 has four grooves 120 and is provided with 3.5 turns of cable 36, the latter having one bead 122 every ¾ of a turn of the pulley. Thus, in total, five beads 122 are in mesh with the pulley 66 and are all indicated, in solid or broken line as appropriate, in FIG. 7, the cable 36 not being reproduced in order not to overload the drawing.

The beads are distributed along the cable 36 in such a way that, while keeping the turns together contiguously, any contact between two beads is avoided. Friction and operating noise are thus minimized.

The way in which the device works is similar to the way explained with respect to FIGS. 5 and 6, the alternative form of FIGS. 7 and 8 having the advantage of developing a higher drive capacity of the cable 36.

One alternative form, not depicted, consists in equipping the return member 41 of FIG. 3 with a pulley with a hollowed surface 74, like the one depicted at 66 in FIG. 5 or FIG. 7, with a variable number of turns of the cable.

Furthermore, it will obviously be understood that the number of turns of the cable on the pulley 66 can vary, the indicated value of 3.5 turns given above having merely been an illustrative value. Without departing from the scope of the invention, a lower or higher number of turns may be chosen.

Furthermore, it will be readily understood that, if the architecture of the vehicle does not allow fitting and transmission of driving torque at the front of the rail 8, the overall orientation of the device according to the invention may be reversed. The drive member is therefore moved to the rear end of the rail 8 and the cable return member is mounted at the front end of this rail.

In addition, the device according to the invention can be mounted with equal ease on any of the three rails, depending on the architecture of the vehicle.

Incidentally, the cross-sectional profile of the drive rail 8 is unimportant provided that it allows a carriage suited to this rail to move along and allows a strand of the flexible hauling element 36 to return, particularly concealed under a bent wall, like the bent wall 21.

Finally, one and the same sliding door may be driven by several synchronized devices according to the invention, each device being arranged on a different rail.

1. Drive device for a motor vehicle sliding door, of the type comprising:
a mechanical member (94) for transmitting a torque (C) provided by a slaved motor (86), the said member and the said motor being arranged at least partly inside the vehicle (1),
a flexible hauling element (36) located outside the vehicle (1) and to which the door (2) is connected via a carriage (10) that can move in a drive rail (8), the said rail delimiting an external contour (22) for holding on part of the bodywork (12) of the vehicle (1), characterized in that it comprises, at one end (15) of the rail (8), a member (61) for the reversible driving of the hauling element, connected to the transmission member (94), and, at the other end (17) of the rail, a member (41) for returning the hauling element.

2. Device according to claim 1, characterized in that the return member (41) is arranged more or less inside the continuation of the external contour (22) of the rail.

3. Device according to one of the preceding claims, characterized in that the drive member (61) is arranged more or less inside the continuation of the external contour (22) of the rail.

4. Device according to one of the preceding claims, characterized in that the return member (41) comprises an element (42; 110) for guiding the rotation of the hauling element (36) about a return axis (44).

5. Device according to claim 4, characterized in that the return member (41) is housed in a casing (52) that is stationary with respect to the rail (17), and in that the return member (41) comprises means (48, 51; 51, 112) for tensioning the hauling element (36) by shifting the return axis (44) with respect to the casing (52).

6. Device according to claim 5, characterized in that the tensioning means comprise a spring (51) bearing against the rotational-guidance element (42; 110), the said element being able to move in translation along the longitudinal axis of the end of the drive rail (17).

7. Device according to claim 6, characterized in that the rotational-guidance element consists of a pulley (42), the spring (51) pressing indirectly against this pulley via a yoke (48).

8. Device according to one of the preceding claims, characterized in that the drive member (61) comprises a pulley (66) for driving the hauling element (36) by friction, comprising at least one wrapping of the hauling element.

9. Device according to claim 8, characterized in that the point at the start of wrapping and the point at the end of wrapping of the hauling element (36) around the pulley (66) lie on the same side of the pulley that faces towards the end of the drive rail (15).

10. Device according to one of claims 8 and 9, characterized in that the pulley (66) comprises a cylindrical central portion which transversely has a concave profile which defines a hollowed surface (74) keeping the wrappings of the hauling element (36) contiguous without overlap.

11. Device according to one of claims 8 to 10, characterized in that the surface (74) of the cylindrical central part of the pulley (66) comprises at least one groove (120) oriented more or less along the axis of the pulley (66), and in that the hauling element (36) consists of a cable comprising, at least in its part designed to be wrapped around the pulley (66), beads (122) secured to the cable and of a shape that is the conjugate of the groove (120).

12. Device according to claim 11, characterized in that the distance between two successive beads (122) is more or less equal to a multiple of the peripheral distance separating two successive grooves (120).

13. Device according to claim 12, characterized in that, in the case of a pulley (66) comprising four grooves (120), the beads (122) are distributed at a spacing more or less equal to a multiple of three-quarters of the perimeter of the pulley.

14. Device according to one of the preceding claims, characterized in that the drive rail (8) delimits a space (20) for holding the carriage (10), and in that the hauling element (36) comprises two ends (36A, 36B) arranged inside the holding space (20) and a return strand (36C) running alongside the drive rail outside the said space.

15. Device according to claim 14, characterized in that the drive rail (8) is provided with at least one runner (40) for the sliding of the return strand (36C).

16. Device according to one of the preceding claims, characterized in that the carriage (10) comprises two guide rollers (96) between them delimiting a gap comprising at least one location (38A, 38B) for fixing the ends of the hauling element (36).

17. Device according to claim 16, characterized in that the carriage (10) comprises a connecting strip (38) connecting the two fixing locations (38A, 38B) together.

18. Motor vehicle equipped with at least one sliding side door, characterized in that it is provided with a device for driving the said door according to one of claims 1 to 17.
